(19) United States
(12) Patent Application Publication
(10) Pub. No.: US 2005/0151847 A1
(43) Pub. Date: Jul. 14, 2005

(54) Surveillance system including non-audible sound emitting event detectors

(76) Inventors: Joseph W. Marks, Belmont, MA (US); Richard C. Waters, Concord, MA (US)

Correspondence Address: Patent Department;Mitsubishi Eelectric Research Laboratories, Inc., 201 Broadway, Cambridge, MA, 02139, US

(21) Appl. No.: 10/753,690

(22) Filed: Jan. 8, 2004

(51) Int. Cl. H04N 7/18

(52) U.S. Cl. 348/155; 348/143

(57) ABSTRACT

A surveillance system includes an event detector mounted in an environment, and an ultrasound generator coupled to the event detector. The ultrasound generator emits an ultrasound signal in response to the event detector detecting an event in the environment. A camera acquires a visual signal of the environment, and a microphone acquires the ultrasound signal, both of which are recorded on a storage media for subsequent searching and indexing. An event detector/ultrasound generator pair, can be purely mechanical or a battery operated electronic circuit.

### FIELD OF THE INVENTION

This invention relates generally to surveillance systems, and more particularly to surveillance systems that acquire visual and sound signals.

### BACKGROUND OF THE INVENTION

Video surveillance is used extensively to monitor public and private areas. When a significant event has occurred, the video can be reviewed to obtain visual information related to the event. In large-scale surveillance systems, where hundreds of cameras may be used, searching for such events is very time consuming.

A number of techniques are known for automatically summarizing and indexing videos to facilitate the search. However, those techniques are not very specific. For example, automatic searches can identify portions of a video in which people or objects are moving, or human faces are visible. In general, automatic search techniques are incapable of identifying specific significant events, and therefore, those techniques are of limited use.

Assuming that video and audio are captured simultaneously, videos can also be automatically summarized or indexed using the recorded audio signal. Audio-based summarization and indexing techniques are particularly useful for recorded television broadcasts. However, eavesdropping laws preclude the use of unauthorized audio recordings in public areas.

Even when not prohibited by law, audio recording in the real world is much less effective than the recorded audio on broadcast videos. Ambient noise, echoes, and the non-specificity of many real-world sounds make it very difficult to effectively index a videotape based on a concomitant recording of general real-world sounds.

In addition to acquiring video and audio signals, surveillance systems can use various control devices such as infrared motion detectors and mechanical or magnetic switches to control recording. For example, a system might record only when motion is detected. However, such control devices are typically expensive to install and often not very specific for the events they detect.

Therefore, there is a need for an improved surveillance system that facilitates summarization and indexing for the purpose of searching videos for specific significant events.

It should be noted that using ultrasound in conjunction with surveillance systems is known in the art, see U.S. Pat. No. 5,920,521, “Ultrasound area surveillance system,” issued to Kromer et al. on Jul. 6, 1999, and U.S. Pat. No. 5,973,996, “Ultrasound intrusion detector,” issued to Zhevelev et al. on Oct. 26, 1999, and references therein. However, in all of those systems, the ultrasound is used only as part of a motion detector to detect the presence of a moving object in an area.

### SUMMARY OF THE INVENTION

A surveillance system includes an event detector mounted in an environment, and an ultrasound generator coupled to the event detector.

The ultrasound generator emits an ultrasound signal in response to the event detector detecting an event in the environment.

A camera acquires a visual signal of the environment, and a microphone acquires the ultrasound signal, both of which are recorded on a storage media for subsequent searching and indexing.

The detector can be a spring-loaded hammer and the generator a bell or tuning fork adjacent to the hammer. Alternately, the detector can be an accelerometer and the generator a battery operated ultrasound circuit and speaker.

### BRIEF DESCRIPTION OF THE DRAWINGS

FIG. 1 is a block diagram of a surveillance system according to the invention.

### DETAILED DESCRIPTION OF THE PREFERRED EMBODIMENT

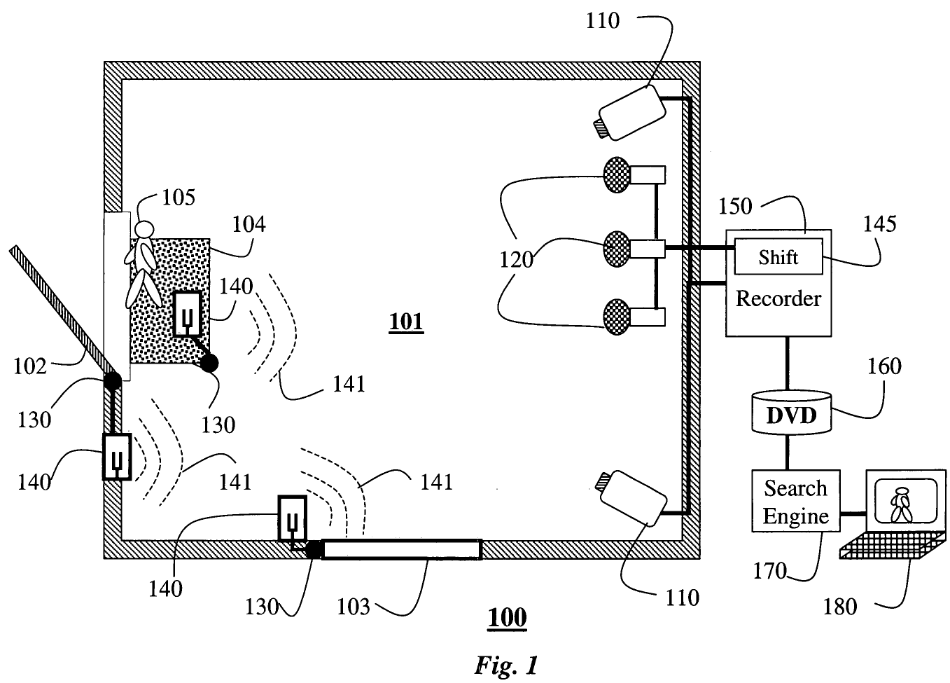

FIG. 1 shows a surveillance system 100 according to the invention for an environment 101, for example a room or place of business. One or more cameras 110 and one or more ultrasound microphones 120 are installed in the environment. In the preferred embodiment, the microphones do not detect human speech signals, normally frequencies in the range 20 HZ to 20 KHz.

The room also includes one or more event detectors 130, which are activated when an event occurs, for example, opening a door 102, a window, 103 or stepping on a mat 104. The event detectors can also be coupled to equipment in the room, e.g., a cash register or cabinet.

There are a great variety of possible event detectors. One possibility is a detector that detects its own motion. This can be used to detect things like the opening and closing of doors and windows or a cash register. In a simple embodiment, such a detector could be a spring-loaded hammer. Alternative, the event detector can be an accelerometer. Alternatively, many other kinds of event detectors are possible, including motion sensors or infrared sensors, Any kind of device is possible as long as it detects some kind of occurrence.

Each event detector 130 is coupled to an ultrasound generator 140, e.g., a mechanical ultrasonic bell or an electronic ultrasound generator circuit. The ultrasound generator emits an ultrasound signal 141 when an event is detected. The signal 141 is inaudible to a person. While each event detector typically has its own generator, it is possible for two or more event detectors to be coupled to the same generator.

The ultrasound signal 141 is acquired by one or more microphones 120. The signal 141 can also be used to activate the cameras 110 to acquire images. In the case that the cameras operate continuously, but at a relatively slow frame rate, e.g., 1 frame per second (fps) the signal 141 can be used to increase the frame rate to a higher frame rate, e.g., 30 fps, or to direct the camera at specific locations.

The signals 141 and the images are stored by a recorder 150 on a storage device 160, e.g., a memory, a video cassette or a DVD, as a ‘video’. Herein, a video is any combination of a visual and audio signal recorded on any type of media. In the preferred embodiment, the frequency of the ultrasound signal 141 is shifted 145 to a lower frequency in the normal audio range so that conventional audio recorders can be used to record the frequency shifted ultrasound.

The signals 141 can be used to summarize, index, and search the video for significant events using a search engine 170. The search engine includes a graphical user interface (GUI) 180.

In the case where multiple detectors 130 are used, each detector can cause the associated generator to emit a unique non-audible signal 141, e.g., a predetermined sequence of tones, or a tone at a predetermined frequency. The unique signals facilitate the searching 170 for specific events, e.g., door or window openings.

The surveillance system according to the invention has a number of very useful properties. Because the ultrasound signal is used, there is no need to run communication wires between the event detector and the surveillance recorder. Rather ultrasonic sound waves travel through the air from the generators to the microphones. If the detector/generator is mechanical or battery operated, then no electrical power wiring is needed, and the detector is particularly cheap and easy to install.

The benefits of reduced installation costs could be applied to the cameras 110 by using ultrasound to communicate information between the cameras 110 and the recorder 150 via the microphones 120 instead of using wires.

Because the signal is not audible to people, it does not disrupt activities in the environment, nor is the signal audible to an unwanted intruder 105. Also, the signal 141 can be made quite loud compared to the ambient sound level in the environment to improve the signal-to-noise ratio, and the searching. Furthermore, the microphones cannot detect speech signals, and thus are in compliance with eavesdropping laws.

If multiple microphones are used, then triangulation can be used to determine the exact location of the events. If the cameras are motorized, then the cameras can be oriented to focus on the location of the event.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

1. A surveillance system, comprising:
an event detector mounted in an environment;
an ultrasound generator coupled to the event detector, the ultrasound generator configured to emit an ultrasound signal in response to the event detector detecting an event in the environment;
a camera configured to acquire a visual signal of the environment;
a microphone configured to acquire the ultrasound signal;
means, coupled to the camera and the microphone, for recording the visual signal and the ultrasound signal on a storage media.

2. The system of claim 1, in which the microphone only acquires sound signals at frequencies different than frequencies of human speech.

3. The system of claim 1, in which the detector and generator are mechanical devices.

4. The system of claim 3, in which the detector is a spring-loaded hammer, and the generator is an ultrasound bell.

5. The system of claim 3, in which the detector is a spring-loaded hammer, and the generator is an ultrasound tuning fork.

6. The system of claim 1, in which the detector is a motion sensor.

7. The system of claim 1, in which the acquired ultrasound signal controls a frame rate of the camera.

8. The system of claim 1, in which the acquired ultrasound signal controls the acquisition of the visual signal.

9. The system of claim 1, further comprising:
a plurality of microphones.

10. The system of claim 9, in which the ultrasound signal acquired by the plurality of microphones is triangulated to determine a location of the ultrasound generator.

11. The system of claim 10, in which the camera is directed at the location determined by the triangulation.

12. The system of claim 1, in which a frequency of the ultrasound signal is shifted to a human audible frequency before the recording.

13. The system of claim 1, further comprising:
means for searching the video based on the recorded ultrasound signal.

14. The system of claim 13, wherein the recorded ultrasound signal is shifted to a lower frequency.

15. The system of claim 1, further comprising:
a plurality of event detectors, each event detector coupled to a corresponding ultrasound generator, each ultrasound generator emitting a unique ultrasound signal.

16. The system of claim 1, in which a volume of the ultrasound is louder than an ambient sound level in the environment.

17. The system of claim 1, in which the microphone includes a filter for filtering out human speech signals.

18. The system of claim 1, in which the recorded visual signal and the recorded ultrasound signal is in a form of a video

19. The system of claim 1, further comprising:
a plurality of cameras.

20. The system of claim 1, in which the event detector is a motion sensor.

21. The system of claim 1, in which the event detector is an infrared sensor.

22. The system of claim 1, in which the event detector is an accelerometer.

23. The system of claim 1, in which the ultrasound generator is an ultrasound circuit and speaker.

24. The system of claim 1, in which communication via ultrasound signals is used to couple the camera and the recording means.

25. A method for providing surveillance of an environment, comprising:
detecting an event in the environment;
generating an ultrasound signal in response to detecting the event in the environment;
acquiring a visual signal of the environment;
acquiring the ultrasound signal; and
recording the visual signal and the ultrasound signal on a storage media.
